(19) United States
(12) Patent Application Publication
(10) Pub. No.: US 2007/0178028 A1
(43) Pub. Date: Aug. 2, 2007

(54) Apparatus for production of metal chloride

(76) Inventors: Eiichi Fukasawa, Chigasaki-shi (JP); Fumito Arai, Chigasaki-shi (JP); Masashi Yamamoto, Chigasaki-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/590,323

(22) PCT Filed: Feb. 18, 2005
(86) PCT No.: PCT/JP05/02594

§ 371 Date: Aug. 23, 2006

(30) Foreign Application Priority Data
Feb. 23, 2004 (JP) 2004-046090
Nov. 19, 2004 (JP) 2004-335734

(51) Int. Cl. B01J 8/00

(52) U.S. Cl. 422/220; 422/240

(57) ABSTRACT

Porous plate 13 is disposed between wind box 11 of dispersion board B and cylindrical vessel wall 12. Filling layer 14 of a structure packed with ceramic particles such as those of fused silica is disposed on the porous plate 13 so as to fill the inside of the cylindrical vessel wall. The filling layer 14 is composed of ceramic particles, so that the corrosion wear by chlorine gas can be inhibited and the durability thereof enhanced. Furthermore, a chlorine resistant member is disposed in a form so as to adhere to the internal surface of the cylindrical vessel wall 12, so that the corrosion wear by chlorine gas of the cylindrical vessel wall 12 can also be effectively inhibited. As a result, damage to the internal wall of the chlorination furnace can be minimized, and the state of allowing chlorine gas to be uniformly dispersed and supplied to fluidized bed 4 containing titanium ore and coke can be maintained for prolonged periods.

### TECHNICAL FIELD

The present invention relates to a production apparatus in which raw materials, such as metal oxide or metal and chlorine gas, are contacted to perform chlorination in a chlorination furnace, and in particular, relates to a structure of a distributor arranged in a chlorination furnace which is a production device for metal chlorides.

### BACKGROUND ART

Titanium tetrachloride, which is one of the metal chlorides, is widely employed for producing titanium sponge or titanium oxide, and electronic materials. Titanium tetrachloride is efficiently produced by using the above-described chlorination furnace.

In such a chlorination furnace for production of titanium tetrachloride, a distributor, which disperses chlorine gas, is arranged at the bottom part of the apparatus. Titanium ore and coke, which are raw materials of titanium tetrachloride, are supplied from the side opening of the chlorination furnace into a fluidized bed formed above the distributor. Chlorine gas is supplied into this fluidized bed through the distributor, and the titanium ore and coke are reacted each other with chlorine gas in the fluidized bed to be chlorinated to the titanium tetrachloride gas.

The titanium tetrachloride gas produced through the chlorination reaction is transported to a cooling zone via the conduit in the top portion of the chlorination furnace and is continuously cooled below its boiling point. The titanium tetrachloride gas produced in the chlorination furnace contains such impurity gases as iron chloride or silicon chloride derived from the titanium ore, and these impurity gases are cooled and removed from the titanium tetrachloride gas during the cooling process in which titanium chloride gas is cooled below its boiling point and separated from the impurity gases. The titanium tetrachloride gas without impurity gas is further cooled below the boiling point and recovered as liquid titanium tetrachloride.

In the conventional distributor units for the fluidized bed reactor in the chemical reaction mentioned above, one distributor unit having many nozzles is disclosed in Japanese Unexamined Patent Application Publication No. Hei 10 (1998)-180084 (hereinafter simply referred to as the “nozzle type configuration”), and the other distributor unit consisting ceramic particles such as silica filled therein is disclosed in Japanese Unexamined Utility Model Application Publication No. Sho 63 (1988)-115435 (hereinafter simply referred to as the “packed-bed type configuration”).

In the distributor unit of the nozzle type configuration, some impurities are frequently precipitated near nozzle openings and as a result the chlorine gas is non-uniformly dispersed, and the chlorination reaction between the chlorine gas and the raw material cannot be performed sufficiently. On the other hand, in the distributor unit of the packed-bed type configuration, the clogging around the openings by impurity precipitation will not frequently occur compared to the nozzle type configuration, so the packed-bed type configuration is desirably employed as a distributor unit.

However, silica pebbles employed as a bed materials packed in the distributor is often crushed, fined, corroded and worn due to the high-temperature chlorine gas during the long term operations, and the dispersion state of the chlorine gas in the fluidized bed becomes getting worse. Therefore, improved solutions regarding this problem have been desired and required.

In addition, a cylindrical vessel wall keeping the bed configuration is arranged on the distributor, and also may be corroded and worn during the long term operation in the chlorination furnace. If the vessel wall on the distributor is corroded and worn, the configuration of the bed becomes irregular, and the chlorine gas flow through the distributor is localized, and fire-resistant material consisting of an inner wall of the chlorination furnace may be corroded. Therefore, improved solutions regarding this problem have been desired and required.

To solve above problems, a technique involving fire-resistant brick comprising fused silica particles having a purity of 99.5% and a porosity of about 1.5% is disclosed in Japanese Unexamined Patent Application Publication No. Hei 01 (1989)-282148. However, even if this brick is used for the bed packed in the distributor in the chlorination furnace for production of titanium tetrachloride, the brick is extremely corroded and worn by high-temperature chlorine gas and ore particles. It is therefore difficult to continue reliable operation for long term operations. Furthermore, even if the brick is used for the inner vessel wall to hold the bed packed in the distributor, cracks occur and terminate long service operations.

As explained above, a distributor unit for supplying chlorine gas, through which titanium tetrachloride gas can be reliably and efficiently produced over long term operations, is desired and required.

### DISCLOSURE OF INVENTION

An object of the invention is to provide an apparatus for production of metal chloride in which a durability of the distributor for chlorine gas is improved, and by which titanium tetrachloride can therefore be reliably and efficiently produced for long term operations.

The inventors have continued the research to achieve the objects described above, and it became clear that the problems can be efficiently solved by constructing the bed packed by ceramic solid particles having high purity and low porosity in the distributor. Furthermore, it became clear that the problems can be efficiently solved by arranging an anticorrosive material for chlorine gas of a ceramic material having high purity close to the inner vessel wall holding the bed packed in the distributor.

That is, an apparatus for production of metal chloride in which raw material including metal oxide or metal (hereinafter simply referred to as “raw material”) is reacted with chlorine gas to perform chlorination of the present invention is characterized in that the apparatus has:
a chlorination furnace in which the raw material is chlorinated by chlorine gas, and
a distributor which is arranged in the chlorination furnace and which helps supplying chlorine gas to disperse in the raw material, and the distributor has a bed packed by solid particles of ceramic material of high purity.

Furthermore, the present invention is characterized in that the anticorrosive material for chlorine gas is arranged closely on the inner surface of the cylindrical vessel wall arranged around the distributor.

In the apparatus for production of metal chloride of the present invention, since the solid particles forming the bed packed in the distributor arranged in the chlorination furnace comprises ceramic material having a porosity of not more than 0.1% and a purity of not less than 99.5%, corrosion and wear of the bed packed in the distributor by chlorine gas can be effectively reduced even after the apparatus is repeatedly used. Furthermore, since the anticorrosion material for chlorine gas is arranged close to the inner vessel wall arranged around the distributor, a circumstance in which the vessel wall of the distributor is corroded and worn directly by chlorine gas during use over long periods can be prevented.

As a result, dispersibility of chlorine gas supplied to the raw material layer can be stably maintained for long term operations. In addition, in the case in which the fluidized bed is formed above the distributor to perform chlorination, the corrosion and wear of the inner wall of the chlorination furnace holding the fluidized bed by chlorine gas can be effectively reduced.

Furthermore, generation of chlorine gas which escapes from the fluidized bed and has not reacted with raw material, and dispersal loss of raw material due to inadequate fluidizing can be effectively reduced. As a result, decrease of yield of metal chloride and increase of exhaust gas process cost can be effectively reduced.

At the bottom part of the distributor of the present invention, a porous plate having numerous holes can be arranged. By supplying chlorine gas to the bed packed in the distributor through the porous plate, chlorine gas can be supplied uniformly to the raw material layer, thereby enabling dispersion and supply of chlorine gas efficiently to the raw material forming the raw material layer.

In the apparatus for production of metal chloride of the present invention, since the solid particles of ceramic material forming the bed packed in the distributor arranged at the bottom part of the chlorination furnace are dense and have high purity, corrosion and wear due to the chlorination by chlorine gas can be effectively prevented even during continuous use over long periods, and as a result, the life of the chlorination furnace can be extended.

Furthermore, since the anticorrosive material for chlorine gas is arranged closely on the inner vessel wall around the distributor, the corrosion and wear of the vessel wall can be effectively reduced, and therefore the service life of the chlorination furnace body can be prolonged.

### BRIEF DESCRIPTION OF THE DRAWINGS

FIG. 1 is a drawing showing a cross section of the chlorination furnace used as the apparatus for production of titanium tetrachloride according to an embodiment of the present invention.

FIG. 2 is a drawing showing a magnified cross section of the distributor used in the chlorination furnace of the apparatus for production of titanium tetrachloride according to an embodiment of the present invention.

FIG. 3 is a drawing showing a cross section of the apparatus for production of titanium tetrachloride according to another embodiment of the present invention.

FIG. 4 is a drawing showing a cross section of the apparatus for production of titanium tetrachloride according to another embodiment of the present invention.

FIG. 5 is a drawing showing a cross section taken along line C-C in FIGS. 3, 4 and 7.

FIG. 6 is a schematic drawing of a method to the anticorrosive material for chlorine gas of the present invention.

FIG. 7 is a drawing showing a cross section of the apparatus for production of titanium tetrachloride according to another embodiment of the present invention.

### EXPLANATION OF REFERENCE NUMERALS

A. Chlorination furnace, 2 . . . Exhaust tube, 4 . . . Fluidized bed, B . . . Distributor, 10 . . . Flange, 11 . . . Wind box, 11A . . . Nozzle, 12 . . . Casing, 13 . . . Multi-hole plate, 14 . . . Packed bed, 15 . . . Anticorrosive material for chlorine gas

### BEST MODE FOR CARRYING OUT THE INVENTION

(1) Construction of the Embodiment

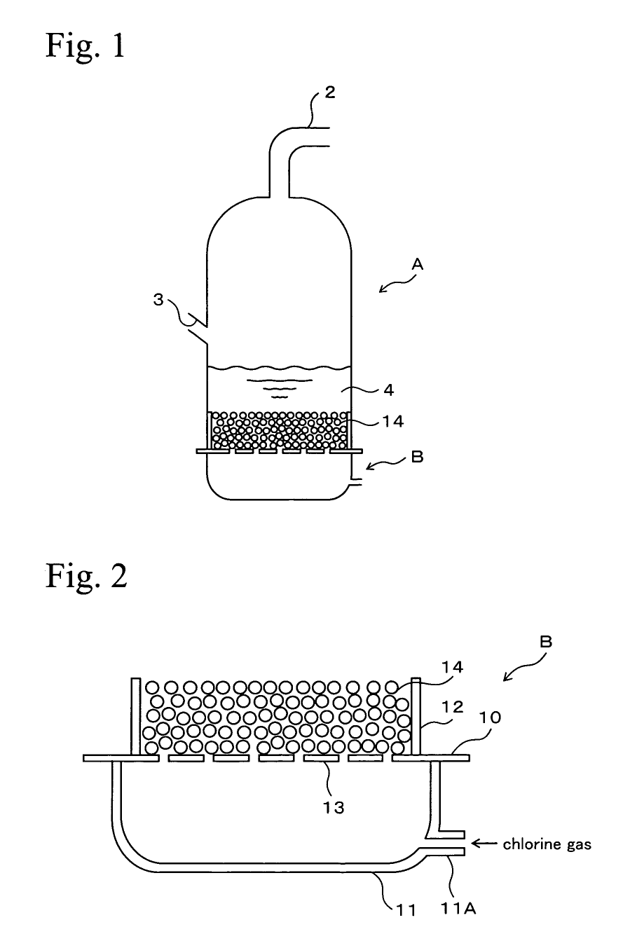

Next, an embodiment of the present invention is explained with reference to the drawings. FIG. 1 shows a side cross section showing a simple overview of a chlorination furnace A applied to an apparatus for production of titanium tetrachloride, in which a fluidized bed is formed at the bottom part of the chlorination furnace to perform the chlorination reaction, in the case in which the metal oxide is titanium ore and the metal chloride is titanium tetrachloride. FIG. 2 shows a magnified cross section showing a simple overview of a distributor B arranged at the bottom part of the chlorination furnace A.

An exhaust conduit 2, which passes titanium tetrachloride gas generated in the furnace to a cooling system, is arranged at the top part of the chlorination furnace A. A supplying tube 3 through which a raw material (not shown) is supplied to the fluidized bed 4 of the chlorination furnace A, is arranged at the side wall of the chlorination furnace A. A distributor B is arranged at the bottom part of the chlorination furnace A, and the fluidized bed 4 containing titanium ore and coke is formed immediately above the distributor.

The distributor B shown in FIG. 2 has a wind box 11 which forms the bottom part of the distributor B, and nozzle 11A, through which chlorine gas is supplied, is arranged in the wind box 11. A cylindrical vessel wall 12 which forms the side wall of the distributor B is arranged at the edge part of the wind box 11, and a flange 10 is arranged on a lower surface of the cylindrical vessel wall 12. The distributor B is connected engaged to the bottom part of the chlorination furnace A via the flange 10.

On the upper surface of the wind box 11, a porous plate 13 having numerous holes is arranged so as to cover the opening part of the wind box 11. A packed bed comprising ceramic solid particles (hereinafter referred to as “ceramic particles”) is formed on the porous plate 13, so as to fill the inner space surrounded by the cylindrical vessel wall 12.

Through the distributor B, chlorine gas is supplied and dispersed to the fluidized bed 4 which is formed above the distributor B. Chlorine gas supplied to the fluidized bed 4 reacts with the raw material to generate titanium tetrachloride gas, and the titanium tetrachloride gas is transported to the cooling system through the exhaust conduit 2 arranged on the top part of the chlorination furnace.

The wind box 11, cylindrical vessel wall 12 and porous plate 13 can be made, for example, of a carbon steel or stainless steel which is generally used for a distributor.

The diameter of the holes in the porous plate 13 can be determined according to the required gas flow rate and pressure loss to disperse chlorine gas. The number of holes of the porous plate 13 differs depending on the diameter of the holes, and for example, in the case of a distributor having a diameter of about 2 m, the desirable number of the holes is in the range from about 50 to 100. When such a porous plate 13 is used, chlorine gas supplied from the nozzle 11A can be dispersed uniformly to the packed bed 14.

The packed bed 14 can be formed by oxides or nitrides, or ceramic particles which are composites of these materials. As such a material, silica or alumina, which is difficult to react with chlorine gas, is desirable.

Furthermore, in particular, fused silica is more desirable. Fused silica is superior from the viewpoint of heat resistance since fused silica is produced in the molten state at high temperature. In addition, since the thermal expansion coefficient of the fused silica is small, pulverization of ceramic particles forming the packed bed 14 can be effectively reduced during the operation of the chlorination furnace.

It is desirable that the purity of the fused silica be high, and in particular, be 99.5% or more. It is desirable that the porosity of the fused silica be low, and in particular, be not more than 0.1%.

The particle equivalent diameter of the ceramic particle is desirably from 5 to 100 mm, and more desirably from 10 to 50 mm. As the equivalent diameter of the ceramic particle decreases, bubbles of chlorine gas released from the packed bed 14 become finer. As a result, it is believed that contact efficiency of chlorine gas released from the packed bed 14 and ore/coke is desirably improved in the fluidized bed. However, if the equivalent diameter of the ceramic particles is less than 10 mm, the ceramic particles unwillingly receive the dynamic energy of the chlorine gas and are scattered in the fluidized bed 4.

On the other hand, larger the equivalent diameter of the particles is, larger the equivalent diameter of bubbles of chlorine gas exhausted from the packed bed 14 become, and the dispersion condition of the raw material in the fluidized bed 4 may be undesirably deteriorated. Therefore, it is desirable that the equivalent diameter of the ceramic particles of the packed bed 14 is in the range from 10 to 50 mm. By filling the ceramic particles having the range in the distributor B, chlorine gas can be efficiently dispersed into the raw material. Furthermore, carry-over loss of the raw material can be effectively reduced.

The sizes of the ceramic particles forming the packed bed 14 are desirably determined so as for bulk density to ultimately be in the range from 1.0 to 5.0 g/cm³, and furthermore, it is more desirable in the range from 1.0 to 2.0 g/cm³. If the bulk density is below the range, the diameter of bubbles of chlorine gas become larger, dispersibility is getting worse, and reaction efficiency of the ore and chlorine gas may be undesirably reduced.

If the bulk density is greater than that range, flow resistance of chlorine gas becomes larger, pressure loss of chlorine gas in the packed bed becomes larger, and back pressure of chlorine gas is undesirably increased.

The shapes of the ceramic particles are not particularly specified, and a spherical shape, plate shape or the like can be employed. Amorphous ceramic particles, prepared by crushing the ceramic agglomerates, may also be employed. It should be noted that it is desirable that the ceramics particles be arranged uniformly on the porous plate 13, and that the ceramic particles be further filled thereon so as to reach the top surface of the cylindrical vessel wall 12.

In this case, vibration energy can be applied to the distributor B to reduce gaps among the particles, and to increase the filled density during the ceramic particles feeding. The vibration energy can form the packed bed 14 more uniformly and densely. As a result, the dispersibility of chlorine gas can be maintained more uniformly.

It is desirable that the equivalent diameter of ceramic particles of the packed bed 14 is in the range from 10 to 50 mm, and it is desirable that larger particles be arranged at an upper part of the packed bed 14 and smaller particles be arranged at a lower part of the packed bed 14.

By arranging the ceramic particles as described above, the ceramic particles of the packed bed 14 are effectively prevented from being scattered into the fluidized bed 4 and from being lost. As a result, dispersibility of chlorine gas can be sufficiently maintained for long periods, and the treatment cost of the chlorine gas can be reduced.

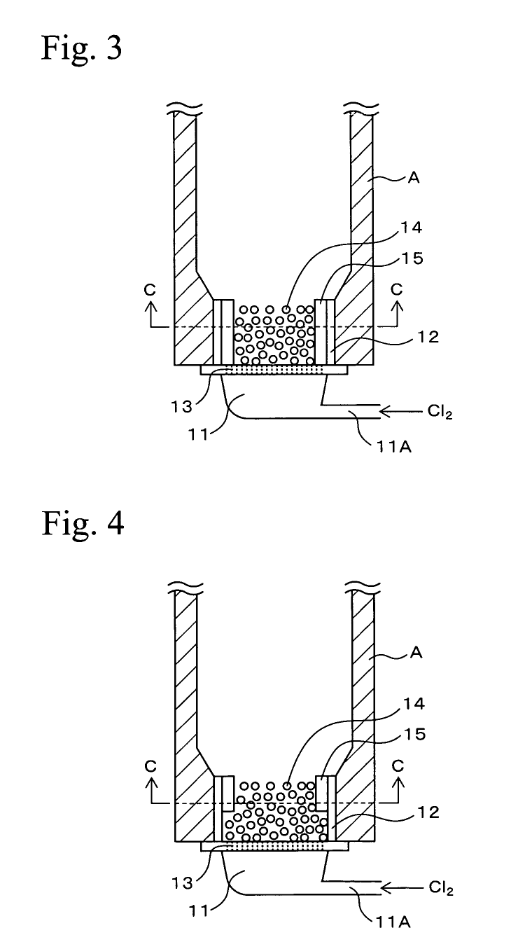

FIG. 3 shows a situation in which the anticorrosive material for chlorine gas 15 of the present invention are laid on an inner wall of the cylindrical vessel 12 arranged around the distributor B, and a situation in which this distributor B is attached on the bottom part of the chlorination furnace. Along the entire length of the inner circumference of the vessel wall 12, the anticorrosive material for chlorine gas 15 are laid. In the area surrounded by the multi-hole plate 13 and the vessel wall 12, ceramic particles are filled to form the dispersing and gas resistance layer for the chlorine gas.

Wind box 11 is connected under the multi-hole plate 13, and nozzle 11A for introducing chlorine gas is arranged at the wind box 33.

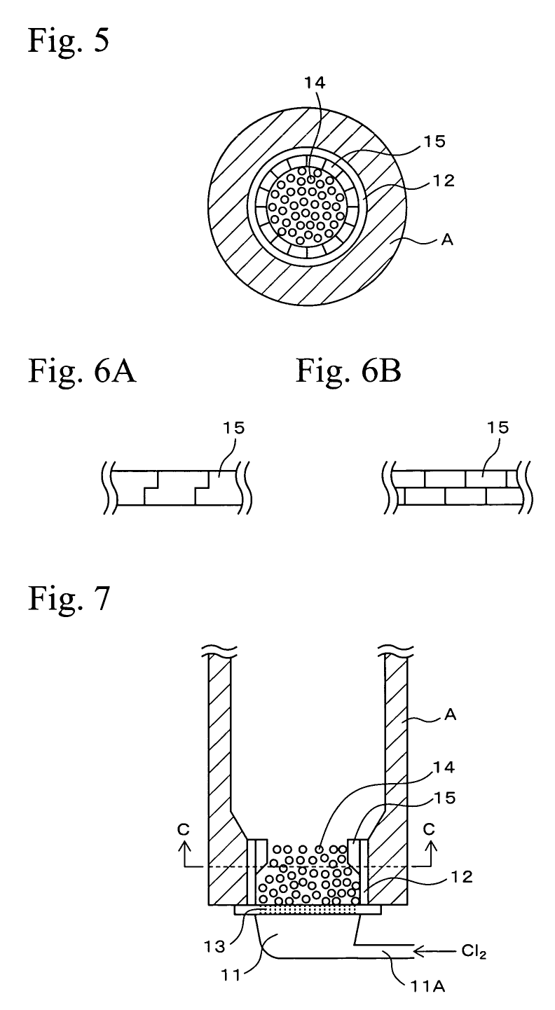

FIG. 5 is a drawing showing a cross section taken along line C-C in FIG. 3. As shown in FIG. 5, the anticorrosive material for chlorine gas 15 are laid along the entire length of the inner surface of the vessel wall 12. Not only are the anticorrosive material for chlorine gas 15 laid closely against the vessel wall 12, the anticorrosive material for chlorine gas 15 are also connected closely to each other. FIG. 6 shows an embodiment showing the anticorrosive material for chlorine gas laid closely to the vessel wall 12, from a direction against the wall. As shown in FIG. 6, segments (repeated constitutional units) of the anticorrosive material for chlorine gas 15 are continuously connected along the horizontal direction, mutually connecting the convex part of one segment and the concave part of another segment closely.

It is not always necessary that the bottom part of the anticorrosive material for chlorine gas 15 of the present invention be laid closely to the entirety of the vessel wall 12 as shown in FIG. 3. For example, as shown in FIG. 4, ceramic particles 14 can be directly contacted to the vessel wall 12 at the lower part.

As a construction closely arranging the anticorrosive material for chlorine gas 15 of the present invention to the vessel wall 12, as shown in FIGS. 6(A) and (B), a rectangular segment of the anticorrosive material for chlorine gas, or a segment of which a convex part is unified to a concave part of a neighboring segment, is continuously connected along the horizontal direction, and as shown in FIG. 5, it is desirable that the segments be laid along the entire length of the circumference of the vessel wall 12. By arranging the segments described above, the anticorrosive material for chlorine gas can be attached closely even to rounded surfaces of the vessel wall 12, and chlorine gas supplied through the multi-hole plate 13 can be prevented from entering into the joining of the anticorrosive material for chlorine gas, and as a result, a corrosion loss of heat resistant material consisting the inner surface of the chlorination furnace body can be effectively reduced. As a shape of the segment, other than that shown in FIG. 6, as long as a segment can be closely and continuously arranged to a neighboring segment, any shape can be employed.

Furthermore, one layer including the discrete segments array shown in FIG. 6 can be piled up closely to another discrete segments array in the vertical direction, to arrange multi-layer segments. In addition, using a segment also having convex and concave portions in the vertical direction, the anticorrosive material for chlorine gas can be laid closely to each other in both the vertical and horizontal directions.

In the dispersing means of the present invention, it is desirable that the inner diameter of a layered anticorrosive material for chlorine gas 15 (hereinafter referred to as the “protected layer”) by which the vessel wall 12 is protected is in the range from 80 to 95% of the diameter of the vessel wall 12. If the inner diameter of the protected layer is less than 80%, the thickness of the protected layer is sufficient to protect the vessel wall 12, although an area of the porous plate 13 from which chlorine gas is blown out is decreased, and therefore, blowing speed of chlorine gas passing through the distributor is increased, and the ceramic particles held in the distributor are undesirably scattered. On the other hand, if the inner diameter of the protected layer is more than 95% of the inner diameter of the vessel wall 12, the thickness of the protected layer is small, and therefore protection efficiency of the vessel wall 12 is undesirably deteriorated.

It is desirable that the anticorrosive material for chlorine gas 15 used for the protected layer be as dense as possible to reduce the invasion of chlorine gas to the side wall of the chlorination furnace body. However, to use the anticorrosive material for chlorine gas as the protected layer of the side wall of the distributor, a member like fire-brick is more desirable practical, as shown in FIG. 4. Since the anticorrosive material for chlorine gas is vulnerable to thermal shocks and cracks may occur easily if porosity is too low, it is desirable that the member have a substantial porosity range. Practically, the desirable porosity is in the range from 5 to 15%. If the porosity is too high, chlorine gas undesirably flows through fine pores in the anticorrosive material for chlorine gas to attack the vessel wall 12.

The lower edge of the anticorrosive material for chlorine gas 15 can be formed as a rectangular shape as shown in FIG. 4, it can also be formed so as to have an oblique interior as shown in FIG. 7. By forming the lower edge of the anticorrosive material for chlorine gas 15 into the oblique shape, resistance given against the anticorrosive material for chlorine gas 15 during passing of chlorine gas can be reduced.

It is desirable that material of the anticorrosive material for chlorine gas 15 of the present invention be selected from fused silica, silicon nitride, or alumina, it is particularly desirable that fused silica which revealed superior chlorine resistance.

It is desirable that the purity of the fused silica consisting the anticorrosive material for chlorine gas 15 be as high as possible, and a purity of not less than 99.5% is desirable.

Materials of the vessel wall 12 and the porous plate 13 holding the ceramic particles are not specified in particular; however, a material having durability, high-temperature resistance and workability is required, and as such a material, carbon steel or stainless steel is desirable.

The inner surface of the vessel wall 12 and the porous plate 13 can be coated beforehand by silica or alumina which forms the anticorrosive material for chlorine gas 15. By performing such a coating treatment, chlorine gas resistance can be improved, and as a result, the life of the chlorination furnace can be prolonged. The coated layer can be formed by flame spraying, for example.

In the conventional distributor shown in FIG. 2, a part of the chlorine gas supplied from the porous plate 13 to the packed bed is contacted to the vessel wall 12, and it may thereby promote corrosion and wear of the vessel wall 12. In addition, accompanied by the corrosion and wear of the vessel wall 12, the brick of the inner wall of the chlorination furnace directly contacts chlorine gas, and the chlorination furnace itself may be corroded and worn. However, in the distributor of the present invention shown in FIGS. 3 and 4, since the superior anticorrosive material 15 for chlorine gas is arranged closely on the inner surface of the vessel wall 12, corrosion and wear by chlorine gas can be effectively reduced. As a result, the apparatus for production of titanium tetrachloride can be reliably operated for long periods.

(2) Operation of the Embodiment

Chlorine gas introduced from the nozzle 11A to the distributor B of the construction shown in FIG. 2 is supplied through the porous plate 13 into the packed bed 14 comprising ceramic particles. Chlorine gas supplied to the packed bed 14 is dispersed uniformly by passing through the gaps among the ceramic particles forming the packed bed 14. Chlorine gas uniformly dispersed is supplied to the fluidized bed 4 comprising ore and coke formed above the packed bed 14.

In this case, since porosity of the packed bed 14 of the present embodiment is low and the packed bed 14 comprises ceramic particles having high purity, corrosion and wear due to reaction with chlorine gas can be reduced. As a result, the life of the distributor B can be prolonged. In addition, uniform dispersibility of chlorine gas to the fluidized bed 4 comprising ore and coke above the distributor B, can also be maintained for long term operation.

As explained above, by using the distributor of the present invention, uniform dispersibility of chlorine gas can be reliably maintained for long term operation. As a result, the fluidized condition of the bed, comprising ore and coke, can be stabilized. In addition, the amount of unreacted chlorine gas escaping from the fluidized bed can be effectively reduced.

The amount of supplied chlorine gas is consumed by reaction with ore and coke; however, at the same time, carbon monoxide gas and carbon dioxide gas are generated with titanium tetrachloride gas, and therefore the total amount of gas is not changed so much. Therefore, stable fluidizing conditions in the entire fluidized bed can be maintained.

As described above, chlorine gas is introduced through the porous plate 13 arranged on the upper surface of the distributor B to the packed bed comprising the ceramic particles 14 and is uniformly dispersed, and then the chlorine gas is dispersed and supplied to the fluidized bed 4 formed above the packed bed.

Since the inner surface of the vessel wall 12 holding the packed bed comprising the ceramic particles 14 is coated by the anticorrosive material for chlorine gas 15 comprising fused silica, chlorine gas introduced from the porous plate 13 does not directly contact the vessel wall 12. Therefore, the conventional situation in which the vessel wall 12 is corroded and worn by chlorine gas, thereby promoting corrosion and wear of the inner wall of the chlorination furnace, can be effectively avoided.

As described above, in the apparatus for production of titanium tetrachloride of the present embodiment, titanium tetrachloride can be produced reliably and effectively for long term operations.

The present invention has been explained as above; however, the present invention is not limited in the embodiment mentioned above, and modifications can be made. For example, the shape of the distributor B, the shape of the holes of the multi-hole plate 13, or the like, can be arbitrarily selected. Furthermore, in the case in which the raw material for chlorination is metal such as silicon or tantalum, the present invention can be effectively applied.

### EXAMPLES

Next, the present invention is further explained in detail by way of practical examples

(Condition of Test and Device)

1) Ceramic Particles

Material: fused silica (purity: 99.8%, porosity: not more than 0.1%)

Particle equivalent diameter: 10 to 50 mm

2) Wind box

Material: carbon steel (SS400)

Outer diameter: 2000 mm

3) Anticorrosive material for chlorine gas

Material: fused silica (purity: 99.8%, porosity: 11%)

4) Chlorine gas

Material: chlorine gas generated from electrolysis of magnesium chloride

Concentration: 95%

Flow amount: 20 m³/min (corresponding to 3000 t-TiCl₄/month·furnace)

5) Ore

Kind: synthesized rutile

Purity of TiO₂: 96%

6) Coke

Kind: calcined coke

### Example 1

Ceramic particles having equivalent diameters from 10 to 50 mm comprising fused silica having a density of 2.7 g/cm³ (purity: 99.8%, porosity: not more than 0.1%) were uniformly arranged on the porous plate 13 of the distributor B shown in FIG. 3 so as to fill the inside of the vessel wall 12. The inner space surrounded by the vessel wall 12 was filled until its top to form the packed bed having a bulk density of 1.3 g/cm³. The distributor having this packed bed was attached to the chlorination furnace, and the chlorination furnace was operated for 18 months. After terminating the operation, the packed bed of the distributor was disassembled for examination. As a result, evidence of the carry-over loss of the surface portion of the fused silica layer was observed; however, the overall initial condition was completely maintained. In addition, there was no alarm sounded due to unreacted chlorine gas detection in the exhaust gas from the chlorination furnace.

### Example 2

Using the apparatus shown in FIG. 3, titanium ore was chlorinated under the conditions mentioned above to produce titanium tetrachloride. During the chlorination, after titanium ore and coke were filled on the dispersion means to form a layer of these raw materials, a predetermined amount of chlorine gas was supplied to produce titanium tetrachloride. The temperature of the wall of the chlorination furnace body was measured at 3, 6, 9, and 12 months after starting of production of titanium tetrachloride; however, noticeable temperature increase was not observed. This fact shows that corrosion and wear of the inner wall bricks of the chlorination furnace were not seriously proceeded. After 18 months from starting of the operation, the chlorination was terminated and the inner wall of the chlorination furnace body was observed; noticeable damage was not observed. Therefore, the partial maintenance and repairing were conducted and the furnace was also reused in the subsequent operation. In addition, pressure loss of chlorine gas passing through the dispersing means was stable, and no blockage of the porous plate of the dispersing means and the packed bed of the ceramic particles was observed.

### Comparative Example 1

The chlorination furnace was operated in conditions similar to that of Example 1, except for small clumps (particle equivalent diameter: 10 to 50 mm) of conventional fused silica refractory (purity: 99.5%, porosity: 1.3%) was used as a material of the packed bed of the distributor. As a result, about 12 months after the starting, the frequency increased of the sounding of the alarm which detects unreacted chlorine gas in the cooling system of the generated titanium tetrachloride. Therefore, operation of the chlorination furnace was stopped and conditions of the distributor were observed. As a result, about 50% of natural quartz, which had been filled until the top part of the distributor at the start of operation, had disappeared.

### Comparative Example 2

Production of titanium tetrachloride was started in an apparatus and under conditions similar to those of Example 2, arranging closely the fused silica refractory used in Comparative Example 1, as an anticorrosive material for chlorine gas 15. Temperature of the wall of the chlorination furnace body was measured at 3, 6, 9, and 12 months after starting the production, and temperature increase of the wall of the furnace was observed at 9 months after starting the operations, and that temperature increase was attributed to the inner wall corrosion and wearing of the chlorination furnace. Therefore, 10 months after starting the operation, chlorination was terminated and the inside of the chlorination furnace was examined. The inner wall of the chlorination furnace of the upper portion of the dispersing means was greatly damaged by corrosion, which seemed to be due to chlorine gas.

As is clear from the results of the Examples, by constructing the packed bed forming the distributor of the present invention, singly with the fused silica particles having superior chlorine gas resistance, it is confirmed that superior durability can be exhibited compared to a case in which conventional fused silica refractory was used.

The present invention is desirable as a dispersion device of a chlorination furnace for production of metal chloride such as producing titanium tetrachloride by chlorinating titanium ore.

1. An apparatus for production of metal chloride in which chlorine gas is reacted with raw material including metal oxide or metal to chlorinate, the apparatus comprising:
a chlorination furnace in which the raw material is held and chlorinated by chlorine gas, and
a distributor which is arranged at the bottom of the chlorination furnace and which supplies and disperses chlorine gas into the chlorination furnace, wherein the distributor comprises a bed packed by pure ceramic particles.

2. The apparatus for production of metal chloride according to claim 1,
wherein the distributor comprises many openings on a plate, and the bed packed pure ceramic particles to which chlorine gas is introduced through the plate.

3. The apparatus for production of metal chloride according to claim 2,
wherein the distributor comprises the plate and a cylindrical vessel arranged on the plate, and wherein an anticorrosive material for chlorine gas is closely laid along the inner wall of the cylindrical vessel.

4. The apparatus for production of metal chloride according to claim 3,
wherein the anticorrosive material for chlorine gas closely laid along an inner wall of the cylindrical vessel comprises discrete segmental plate with which are mutually combined, and
wherein each segment has a convex and concave attachments at both ends thereof, the convex portion of the segment is unified to a concave portion of another segment, and the segments are laid horizontally along the whole inner wall of the vessel.

5. The apparatus for production of metal chloride according to claim 4,
wherein a joint of the segments continuously connected along the inner wall of the vessel, and the connected segments is further piled up vertically as the multi-piled wall along the inner wall of the vessel.

6. The apparatus for production of metal chloride according to claim 3,
wherein the inner wall of the vessel is covered by the anticorrosive material for chlorine gas.

7. The apparatus for production of metal chloride according to claim 14,
wherein the ceramic material packed in the bed on the distributor is at least one kind selected from silicon nitride, alumina, and fused silica.

8. The apparatus for production of metal chloride according to claim 1, wherein the equivalent diameter of ceramic particle packed in the bed on the distributor is in a range from 5 to 100 mm.

9. The apparatus for production of metal chloride according to claim 1,
wherein bulk density of the ceramic particle of the bed on the distributor is in a range from 1 to 5 g/cm3.

10. The apparatus for production of metal chloride according to claim 3,
wherein the anticorrosive material for chlorine gas comprises fused silica, silicon nitride, or alumina.

11. The apparatus for production of metal chloride according to claim 1,
wherein purity of the ceramic material packed in the bed of the distributor is not less than 99.5% and the porosity is not more than 0.1%.

12. The apparatus for production of metal chloride according to claim 10,
wherein the purity of the ceramic material covering the inner wall of the vessel in the distributor is not less than 99.5% and the porosity is in a range from 5 to 15%.

13. The apparatus for production of metal chloride according to claim 1,
wherein chlorine gas is supplied into the chlorination furnace comprising metal oxide or metal, as raw materials to react with chlorine gas.

14. The apparatus for production of metal chloride according to claim 1,
wherein chlorine gas is supplied to a fixed bed in which raw material comprising metal oxide or metal is filled, and the raw material is chlorinated by chlorine gas.

15. The apparatus for production of metal chloride according to claim 1,
wherein the metal oxide of the raw material is titanium ore.

16. The apparatus for production of metal chloride according to claim 1,
wherein the metal raw material is silicon or tantalum.

17. The apparatus for production of metal chloride according to claim 1,
wherein the metal chloride is titanium chlorides, silicon chlorides, or tantalum chlorides.
